(19) United States
(12) Patent Application Publication
(10) Pub. No.: US 2011/0036966 A1
(43) Pub. Date: Feb. 17, 2011

(54) Stay-in-Place Concrete Footing Forms

(76) Inventor: Bryan Benedict, Galion, OH (US)

Correspondence Address: MUELLER AND SMITH, LPA;MUELLER-SMITH BUILDING, 7700 RIVERS EDGE DRIVE, COLUMBUS, OH, 43235, US

(21) Appl. No.: 12/910,958

(22) Filed: Oct. 25, 2010

Related U.S. Application Data
(63) Continuation-in-part of application No. 12/555,234, filed on Sep. 8, 2009, now Pat. No. 7,818,925.
Application No. 12/555,234 is a continuation-in-part of application No. 11/810,646, filed on Jun. 6, 2007, now abandoned.
(60) Provisional application No. 60/812,889, filed on Jun. 12, 2006.
(60) Provisional application No. 60/879,384, filed on Jan. 9, 2007.

(51) Int. Cl. B28B 7/22

(52) U.S. Cl. 249/25; 249/18

(57) ABSTRACT

A stay-in-place concrete footings form is used for forming a concrete footing between a spaced-apart pair of the stay-in-place concrete footings forms. Each concrete footing form is elongate and has a cavity inside the form. Each form has a pair of elongate sides wherein openings are formed in the elongate sides to permit water to flow into the cavity. Each form has a dovetail pin or dovetail slot formed along the lengthwise extent of both sides of the form. The dovetails permit clamps, having a mating dovetail slot or dovetail pin, to be clamped to the form for anchoring the form to the ground with a stake carried by the clamps.

### CROSS-REFERENCE TO RELATED APPLICATIONS

This application is a continuation-in-part of application Ser. No. 12,555,234, filed Sep. 8, 2009; which is a continuation-in-part of application Ser. No. 11/810,646, filed Jun. 6, 2007; and claims benefit of provisional application Ser. No. 60/812,889 filed on Jun. 12, 2006; and provisional application Ser. No. 60/879,384 filed on Jan. 9, 2007; all of said applications entitled “Stay-In-Place Concrete Footing Forms”.

### STATEMENT REGARDING FEDERALLY SPONSORED RESEARCH

Not applicable.

### BACKGROUND OF THE INVENTION

The present invention generally relates to forms for pouring concrete footers and more particularly to a form system that also provides water drainage as a continuous drain tile.

Stay-in-place concrete footing forms are commercially available and used in the home construction industry. One such form system by Alton F. Parker is based on hollow forms that function to also drain water (see U.S. Pat. Nos. 5,224,799, 5,210,162, for example). Another such form system by Patrick S. Pawlicki uses a dovetail in one side of the form for permit the forms to be staked to the ground. An elaborate connection system is proposed to join adjacent such forms (see U.S. Pat. No. 5,015,117).

Despite the availability of these concrete footer form systems, there still is a need in the art for improvements thereto. The present invention is one such improved concrete footer form system.

### BRIEF SUMMARY OF THE INVENTION

A stay-in-place concrete footings form is used for forming a concrete footing between a spaced-apart pair of the stay-in-place concrete footings forms. Each concrete footing form is elongate and has a cavity inside the form. Each form has a pair of elongate sides wherein openings are formed in the elongate sides to permit water to flow into the cavity. Each form has a dovetail pin or dovetail slot formed along the lengthwise extent of both sides of the form. The dovetails permit clamps, having a mating dovetail slot or dovetail pin, to be clamped to the form for anchoring the form to the ground with a stake carried by the clamps.

Advantages of the present invention include the ability to weep water from the soil surrounding the forms by the hollow space within each form. Another advantage is the ability to be staked into the ground via clamps designed to mate with the dovetails formed along the lengthwise extent of each form. These and other advantages will be readily apparent based on the disclosure set forth herein.

### BRIEF DESCRIPTION OF THE DRAWINGS

For a fuller understanding of the nature and advantages of the present invention, reference should be had to the following detailed description taken in connection with the accompanying drawings, in which:

FIG. 1 is an isometric view of the stay-in-place concrete footings form;

FIG. 2 is an isometric view of an alternative embodiment of the stay-in-place concrete footings form;

FIG. 3 is an isometric view of a further embodiment of the stay-in-place concrete footings form;

FIG. 4 is an isometric view of another embodiment of the stay-in-place concrete footings form wherein a dovetail is formed along the top and bottom thereof;

FIG. 5 is an isometric view of the stay-in-place concrete footings form of FIG. 4 having slots formed along the side thereof;

FIGS. 6-8 are partial isometric views of different splines adapted to be lodged in the dovetails of the forms in FIGS. 4 and 5;

FIG. 9 is an isometric view of two adjacent stay-in-place concrete footings form of FIG. 4 having fabric spread therebetween;

FIGS. 10-12 are end view of the stay-in-place concrete footings forms of FIG. 9 showing the placement of the splines of FIGS. 6-8 for retention of the fabric;

FIG. 13 is an end view of two stay-in-place concrete footings forms stacked atop each other;

FIG. 14 is a partial isometric view of a lock for securing the two forms in FIG. 13 together using their dovetails;

FIG. 15 shows the placement of rebar between two adjacent forms with a mask or clip capturing the rebar;

FIGS. 16-18 show additional rebar mask or clip designs;

FIG. 19 is a simplified end view of adjacent, spaced-apart forms similar to those shown in FIG. 15, but with a metal spring rebar clip;

FIG. 20 is an overhead view of the stay-in-place concrete footings forms with rebar in place and anchors holding the forms in position;

FIG. 21 is an isometric view of a corner of the stay-in-place concrete footings form;

FIG. 22 is a cross sectional elevational view along line 22-22 of FIG. 21;

FIG. 23 is an isometric view of the corner piece connector of the stay-in-place concrete footings form;

FIG. 24 is an end view of the corner piece of FIG. 23;

FIG. 25 is an isometric view of one embodiment of a connector that is used to connect two of the stay-in-place disclosed concrete foots form;

FIG. 26 is a cross sectional elevational view along line 26-26 of FIG. 25;

FIG. 27 is an isometric view of the corner piece connector of the stay-in-place concrete footings form showing an alternative “over the top” rebar holder;

FIG. 28 is a front view of the over the top rebar holder of FIG. 27;

FIG. 29 is a side isometric view of the clamp system that holds the stay-in-place concrete footings form in place;

FIG. 30 is a top view of the clamp system shown in FIG. 29; and

FIGS. 31-36 are end views of various additional profiles of the stay-in-place concrete footings forms;

FIG. 37 is an isometric view of a corner connector used to connect two of the disclosed stay-in-place concrete foots forms at a corner;

FIG. 38 is an end view of the corner connector of FIG. 37;

FIG. 39 is an isometric view of another embodiment of a connector that is used to connect two of the stay-in-place disclosed concrete foots form; and

FIG. 40 is an end view of the corner connector of FIG. 39.

The drawings will be described in further detail below.

### DETAILED DESCRIPTION OF THE INVENTION

Referring initially to FIG. 1, a section of a stay-in-place concrete footings form, 10, is shown in perspective view. Form 10 is of thin-wall construction with a pair of hollow cavities, 12 and 14, separated by an elongate central wall, 16, which provides additional structural integrity. Along the lengthwise extent of both sides of form 10 are weep or draining slots, exemplified by a slot, 18. Such slots permit water that accumulates and/or is present adjacent to form 10 to drain into cavities 12 and 14 and thence into a drain or other conveyance. Such slots aid in moving water away from the foundation of the structure built atop the footers formed with the disclosed forms.

It will be understood that the contractor will use a pair of such disclosed forms spaced-apart a suitable distance for pouring concrete between such spaced-apart forms for forming a conventional concrete footer, typically reinforced with rebar or other reinforcement. The disclosed forms are stay-in-place in that they are not removed after the concrete footer cures.

In order to ensure that form 10 stays in place before, curing, and after the concrete footer is poured, a pair of dovetails slots, 20 and 22, is formed along the lengthwise extent of both sidewalls of form 10. Such dovetails can be used in connection a mating dovetail pin carried by a clamp, as disclosed in U.S. Pat. No. 5,015,117, cited above, in order to attached a stake driven into the ground and carried by the clamp. The precise shape of the dovetail pins and slots is not important, as common dovetails, lap dovetails, or other mating configuration can be used for connection purposes, as disclosed herein. Thus, the use of a male/female mating arrangement where the female or slot narrows from its throat to its interior to provide a positive lock can be used to advantage, along with dovetails, keyways, T-slots, or any other male/female positive lock mechanical system, whether with linear, curvilinear, or other geometric profiles, can be used in accordance with the precepts of the present invention. Thus, for present purposes, “dovetail” or “interlock” means a male pin and mating female slot where some portion of the slot cavity is larger (in cross-section) than the throat or opening of the slot which prevents the male pin from pulling out of the female slot.

The dovetail pin or slot along the concrete footer side of the disclosed forms can be “locked” to the concrete footer, which surrounds a dovetail pin or fills a dovetail slot. Such positive locking may even dispense with the need for the clamps and stakes. The disclosed concrete footings form design, however, permits the use of conventional clamps and stakes along with the concrete lock to ensure that the form stays in place during the concrete pour, during the curing of the concrete, and after the concrete footer cures.

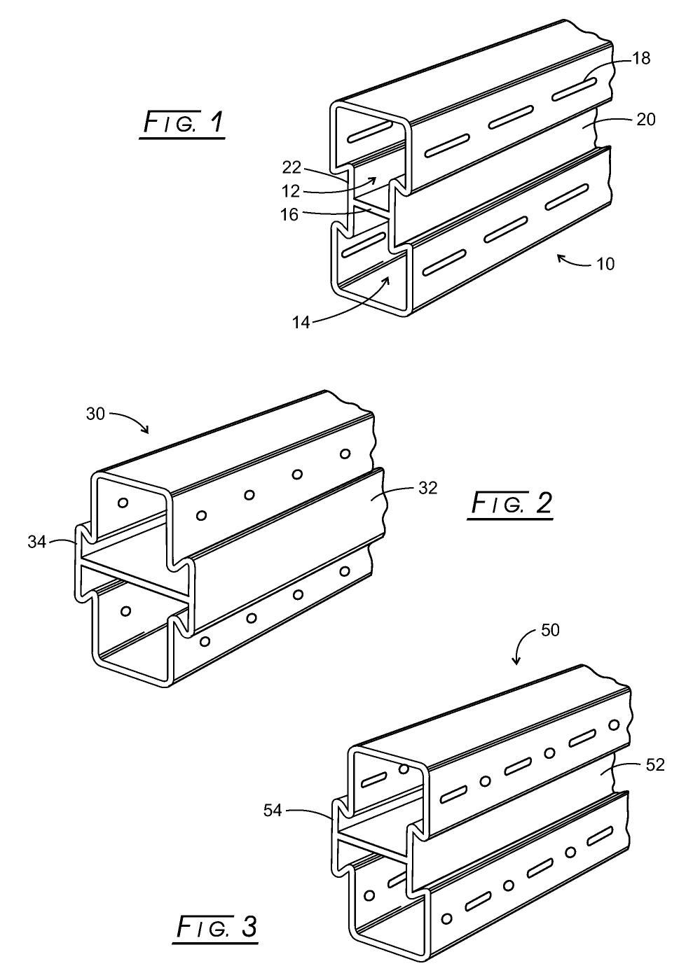

Referring now to FIG. 2, a form, 30, is seen to carry a pair of dovetail pins, 32 and 34, along its lengthwise extent. Again, on such dovetail pin is locked to the concrete while opposite dovetail pin 34 can be secured to a clamp designed with a mating dovetail slot. Form 30 also uses holes to accommodate water to flow to its interior. Slots, holes, or apertures of any configuration, then can be formed into the novel form in accordance with the disclosure set forth herein.

Referring now to FIG. 3, a form, 50, has a lengthwise dovetail slot, 52, and an oppositely disposed lengthwise dovetail pin, 54, for mating with the concrete on one side (either side) and for attaching to a clamp on the other (either) side. Form 50 uses both holes and slots.

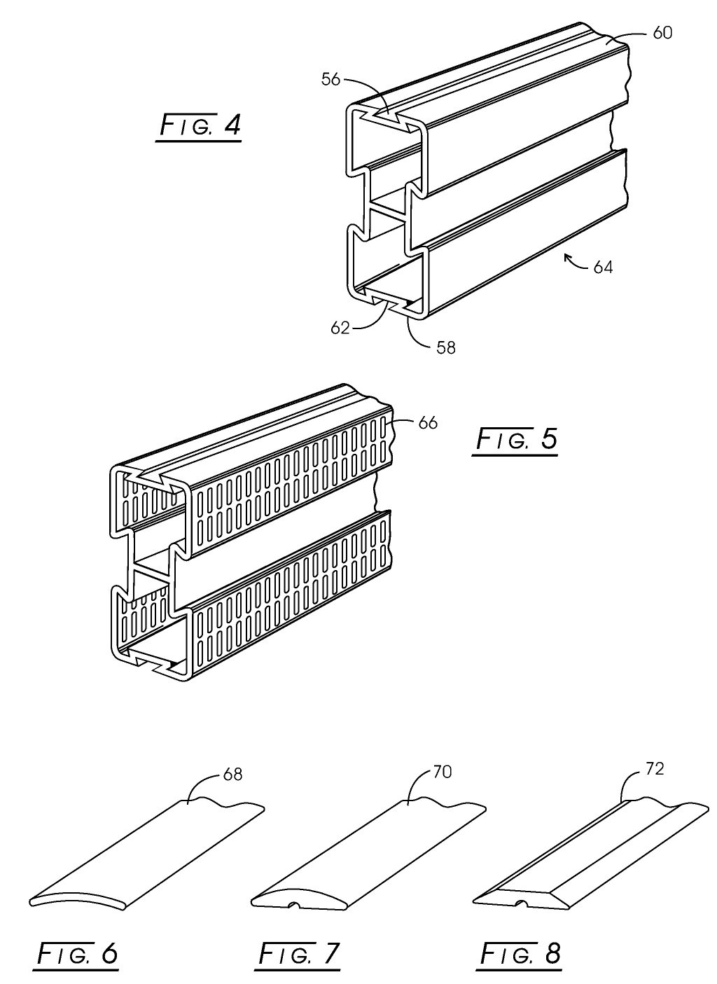

Referring now to FIG. 4, dovetail slots, 56 and 58, have been formed along the top surface, 60, and bottom surface, 62, of a form, 64. Thus, the disclosed concrete footings form has the design flexibility of using dovetail pins, dovetail slots, or a combination of dovetail pins and dovetail slots in any combination on the sidewalls, top wall, and bottom wall. FIG. 5 shows a series of vertical slots, such as a slot, 66, formed in the sidewalls of the form, such as described in connection with FIGS. 1-3. Again, the pattern of apertures and their shape is unimportant and can be left to the forms designer and/or manufacturer to implement. Of importance is that the disclosed stay in place forms function to move water away from the foundation after the structure is formed, while functioning as a conventional form for pouring concrete footers. Again, a unique multi-purpose form is disclosed.

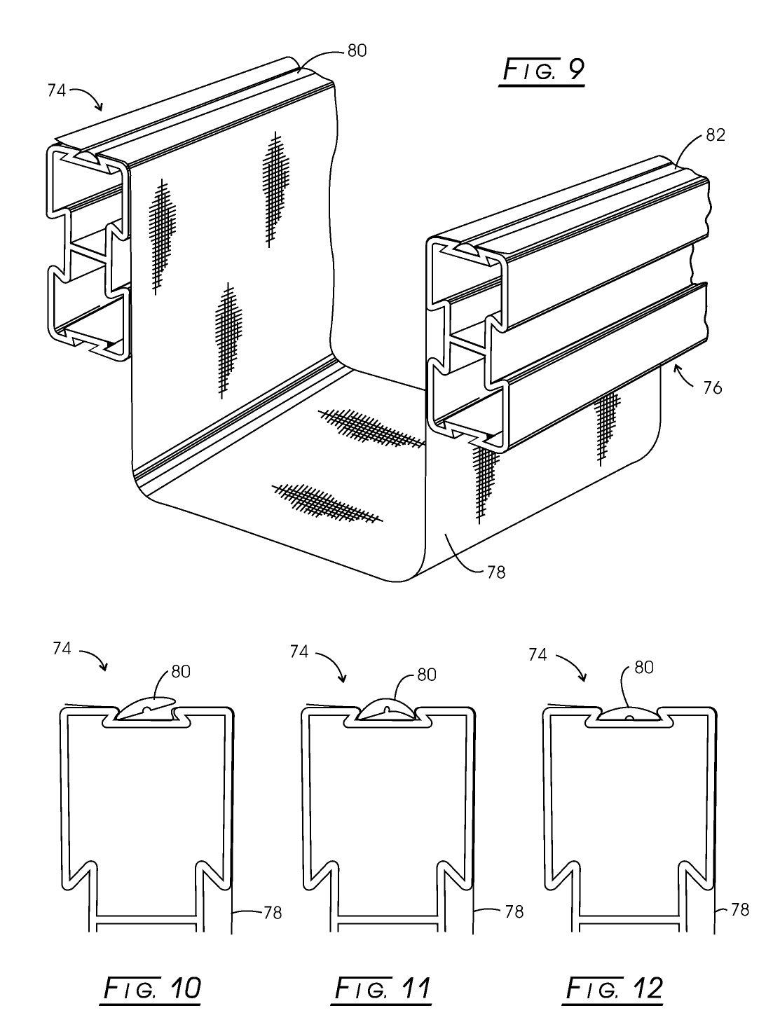

FIGS. 6-8 depict three different designs of splines, 68, 70, and 72, which splines are adapted to be placed in dovetails 56 and 58 of form 64 illustrated in FIG. 4. A variety of different spline designs will be readily apparent to the skilled artisan.

FIG. 9 details the use of the disclosed splines. That is, a pair of adjacent forms, 74 and 76, can be spaced an appropriate distance apart and a fabric, 78, placed between and over the forms. The space between forms 74 and 76 will be filled with concrete, and optionally rebar, for forming a concrete footer. Fabric 78 is held in place with splines, 80 and 82, which are placed, respectively, in the dovetail slots formed along the top of form 74 and form 76.

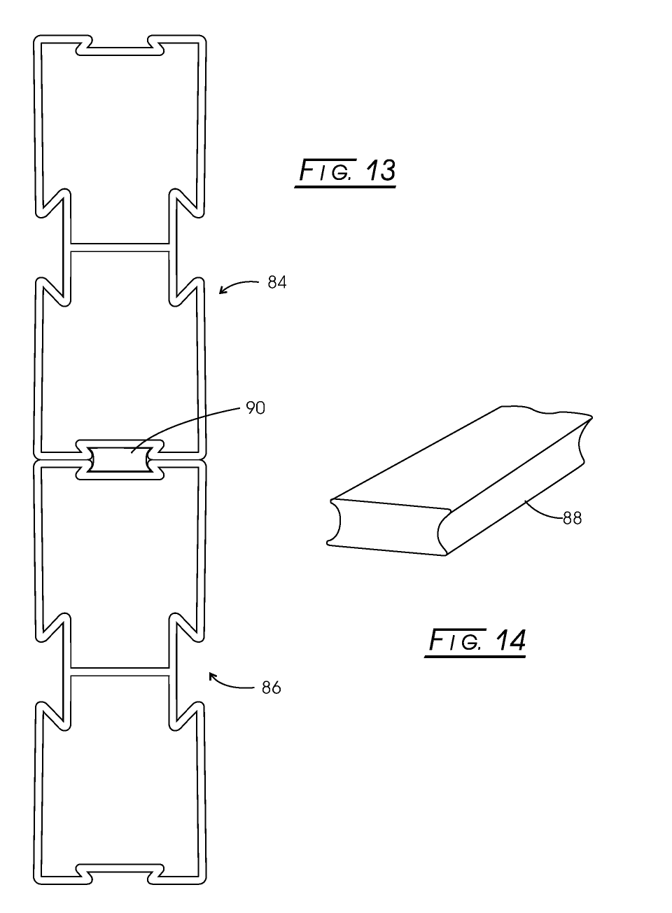

FIGS. 10-12 sequentially detail the spline placement method used to capture fabric 78 for a spline, 80, for form 74. The same method can be used to capture fabric 78 in form 76. Fabric 78 can be formed from plastic or other appropriate material, for example, for containing water. Slots, clips, and/or other attachment means also can be used for retaining the liner in place in addition to the disclosed splines and dovetails. Fabric 78 is relatively thin such that desirably is permits concrete to fill in interior dovetail slots formed in forms 74 and 76 in FIG. 9.

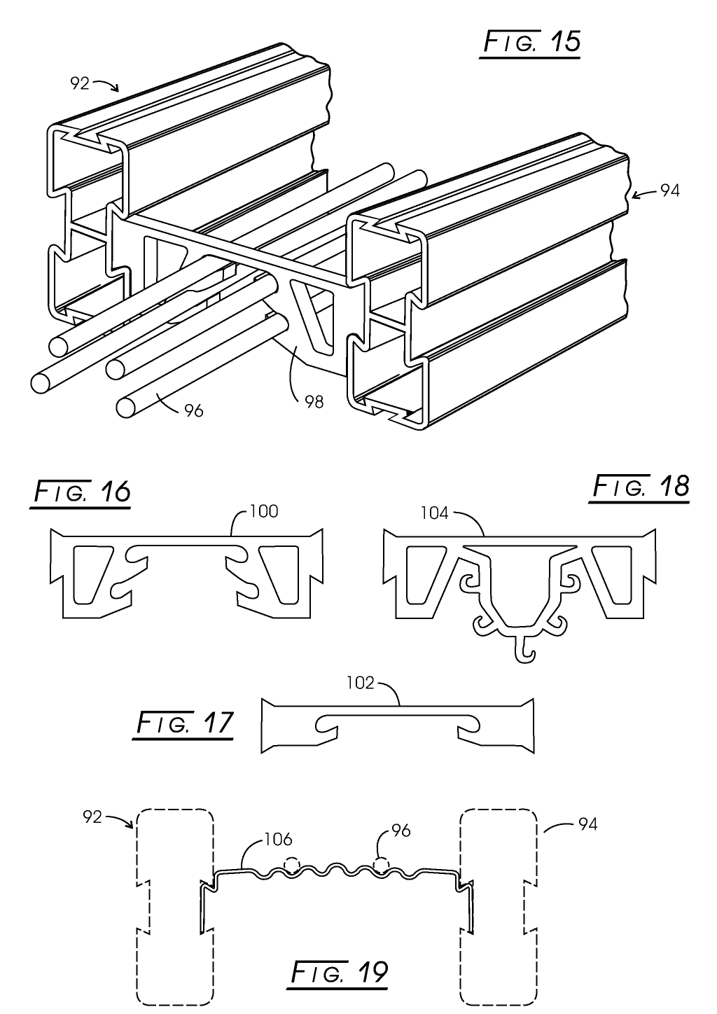

For obtaining additional concrete footer height, the disclosed concrete footer forms can be stacked atop each other, as illustrated in FIG. 13 for forms, 84 and 86. In order to secure forms 84 and 86 together, a lock, 88 (see FIG. 14), can be placed in the cavity, 90, formed by the adjacent dovetail slots in forms 84 and 86. Lock or spline 88 can be provided in a variety of configurations so long as the stacked forms are secured together during the concrete footer pour.

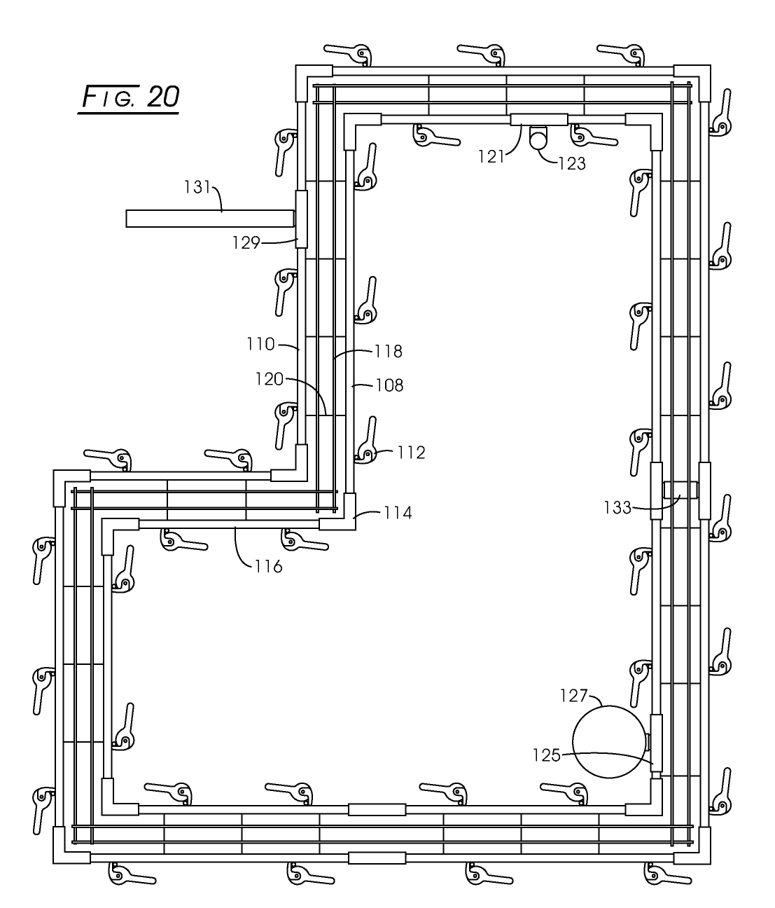

FIG. 15 shows a pair of forms, 92 and 94, in place for pouring a concrete footer. In order to secure the rebar, such as a representative rebar, 96, a mask or clip, 98, is designed in such a pattern as to retain the rebar in the desired location within the footer to be poured. Mask or clip 98 can be retained in place by its outer ears that snugly fit within the side dovetail slots in forms 92 and 94. A plurality of such similarly or differently designed masks or clips can be placed along the extent of forms 92 and 94 at appropriate intervals. Each mask or clip has a pattern of notches in which the rebar snugly fits. FIGS. 16-18 show different representative designs of for clips, 100, 102, and 104. It will be appreciated many additional patterns can be envisioned and are useful in accordance with the present disclosure.

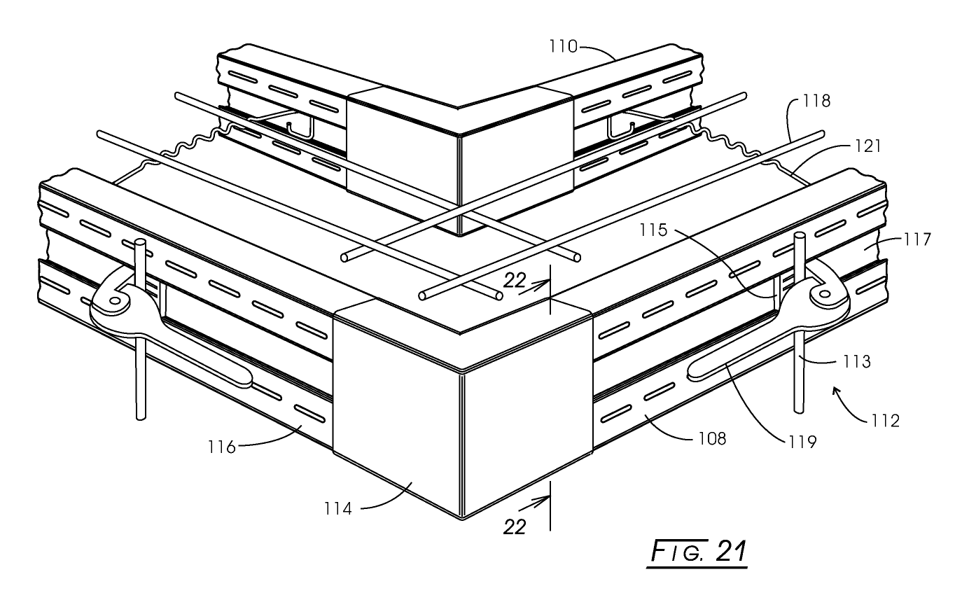

FIG. 19 shows an end view of forms 92 and 94 from FIG. 15, but with a metal spring clip, 106, supporting rebar, 96, and additional rebar, if desired. Metal spring clip 106 can be made slightly longer than the width between forms 92 and 94. The placement of spring clip 106, then, would pre-load or tension it for additional strength. The ends of spring clip 106 lock into the dovetail slots of 92 and 94. The design of such ends can be as illustrated or they can be rounded to fit into only the upper or lower corner of the dovetail. The design of spring clip 106 also is such that it can be installed upside down from the installation depicted in FIG. 19 to vary the depth at which it would hold the rebar. Merely turning FIG. 19 upside down reveals this unique design feature of spring clip 106.

Referring to FIGS. 20 and 21, an entire layout of a foundation formed from the stay-in-place concrete footings forms disclosed herein is shown. In particular, a representative such forms, 108 and 110, form a cavity therebetween for filling with concrete for forming a footer. Clamps, such as represented by a claim, 112, holds the forms in place while the concrete is poured and until the forms are removed. A corner connector, 114, holds form 108 to an adjacent form, 116, disposed at an angle, typically 90°, thereto. Such corner pieces can have geometry for other angles, as is necessary, desirable, or convenient. Inside and outside corner pieces are provided also. Rebar, 118, is typical of the rebar disposed within the cavity formed by the forms for reinforcing the concrete footers. Such rebar is held in place with clips, clip 120, being representative of such clips. Clip designs or geometry may be varied or the same, as determined by the crew establishing the forms. Clip 120 has a bend end that fits within the cavity formed along the inside of forms 108 and 110, as described earlier.

Clamp 112 is a cam-action lock designed to clamp onto a piece of rebar, 113, or other metal (wood or other material) driven into the ground. Clamp 112 has a capture piece, 115, that fits into a slot, 117, formed in the side of form 108. Capture piece 115 can slide in slot 117 to locate clamp 112 anywhere long the length of form 108. By merely moving a lever, 119, the cam lock action holds clamp 112 firmly on rebar 112.

Several straight connectors also are illustrated in FIG. 20 for connection adjacent straight mold sections. One straight connector, 121, is connected to a vertically extending pipe, 123, for radon removal. Another straight connector, 125, is connected to a sump, 127. Yet a further straight connector, 129, is connected to a drain pipe, 131, for removal of water in the forms, optionally with the aid of a pump, for taking the water to a waster water system, to a lawn, etc. A final illustrated straight connected, 133, connects the cavities of the oppositely disposed forms. Additional straight connectors can be used for additional purposes, thus illustrating the flexibility and adaptability of the disclosed stay-in-place forms.

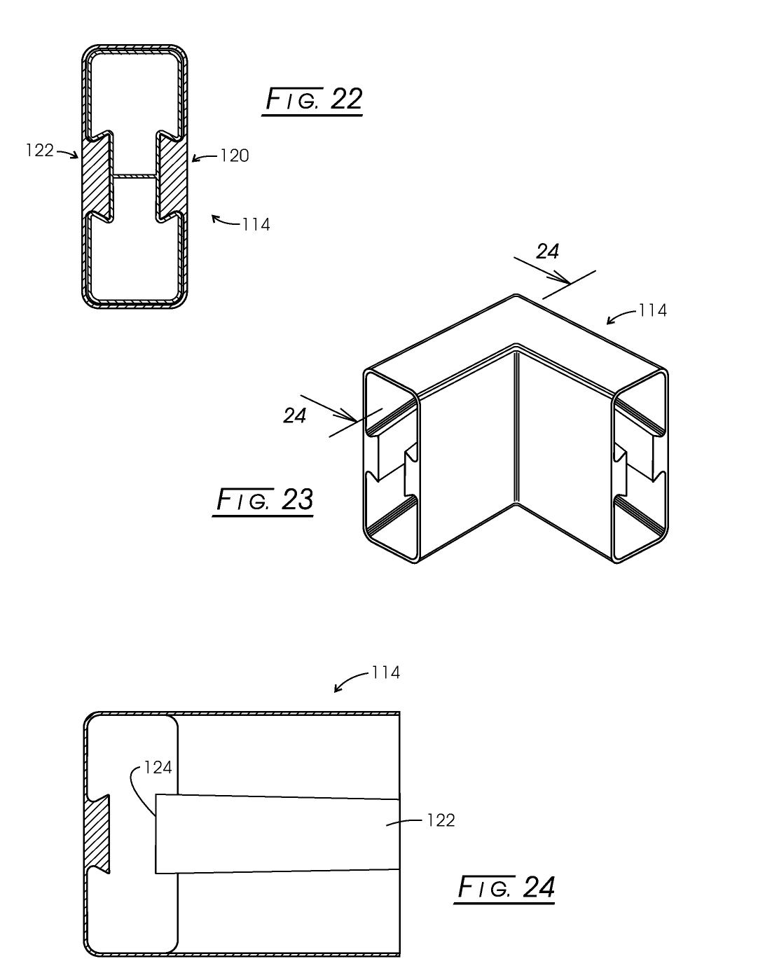

Referring to FIGS. 22-24, corner piece 114 is depicted in perspective and cross-sectional view. The cross-sectional view of corner piece 114 in FIG. 22 reveals exterior keyways, 120 and 122, for mating with their female counterparts on forms 108 and 116 (see FIG. 20). From FIG. 24, it will be revealed that keyway or cavity 122 narrows from its entrance or throat, 124, so as to capture the female keyway and positively lock corner piece 114 to the adjacent forms.

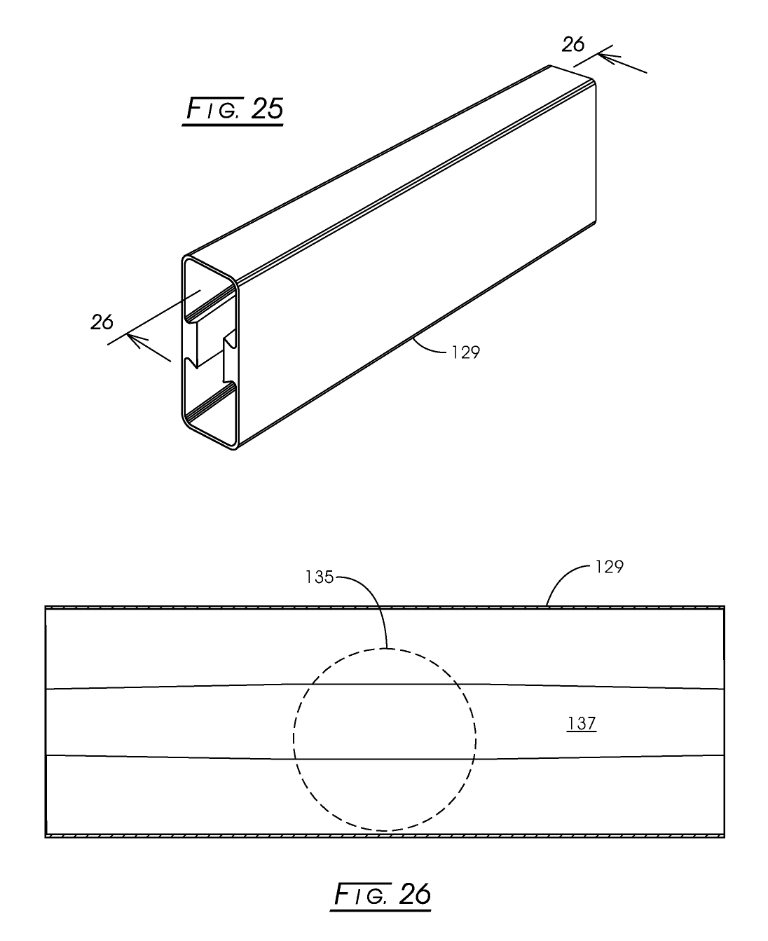

Referring now to FIGS. 25 and 26, straight connector 129 is illustrated. An aperture, 135, shown in phantom receives pipe 131 (see FIG. 20). An interior cavity, 137, is tapered to receive mating keylocks for holding connector 129 tightly to adjacent forms sections.

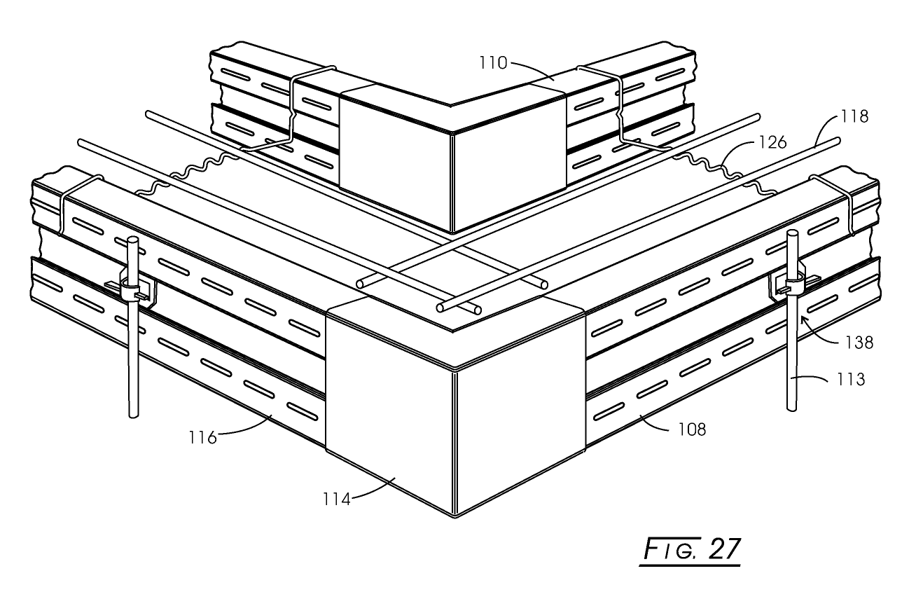

Referring now to FIGS. 27 and 28, an alternative design rebar clip, 126, is seen to have its ends bent to fit over the top of forms 108 and 110. Each end, 128 and 130, of clip 126 is slightly flared to make it easy to press fit over the tops of forms 108 and 110. Slight indentations or nipples, 132 and 134, extend slightly into side cavities on forms 108 and 110 to assist in keep clip 126 in place. Bends, rebar receiving recesses, or detents, such as 136, receive rebar, such as rebar 118. At various such locations, the rebar can be tied down with wire to keep the rebar from moving during pouring of concrete. The several such bends enable the rebar to be placed a various locations and in varying number. It should be observed that indentations or nipples can be made in the ends of clip 126 so as to fit into the outer dovetail cavities. Finally, a score, or other weakness can be made on the inside of clip 126 around locations 137 and 139 to enable the user to break off the ends of clip 126 once the poured concrete footer has sufficiently solidified using pliers or other similar tool.

FIGS. 29 and 30 depict an alternative clamp useful in holding down the molds. Conveniently, rebar 113 is driven into the ground and a clamp affixed between the mold and such rebar. One such clamp, 138, has a slide, 140 that fits in the elongate slot that runs along the extent of the form 108 (see FIG. 27). Slide 140 simply moves along form 108 to any position desired. Slide 140 carries an apertured arcuate portion or J-clip, 142, which fits around rebar 113. A wedge pin, 144, is pushed through the aperture and in contact with rebar 113 and then in biased contact with the end of arcuate portion 142 to hold rebar 113 fast. Clamp 138 can be made from stamped steel or other metal.

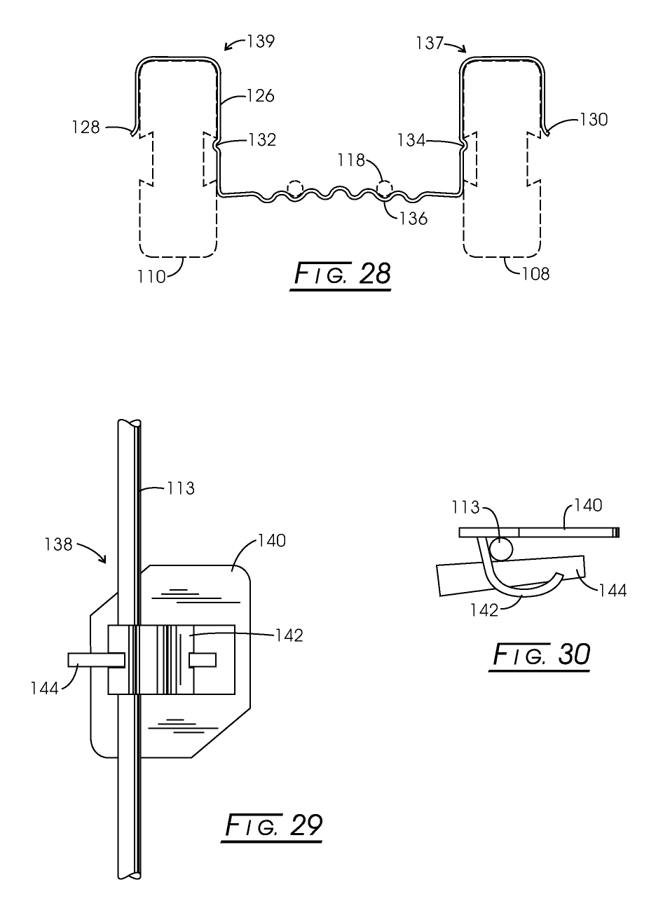

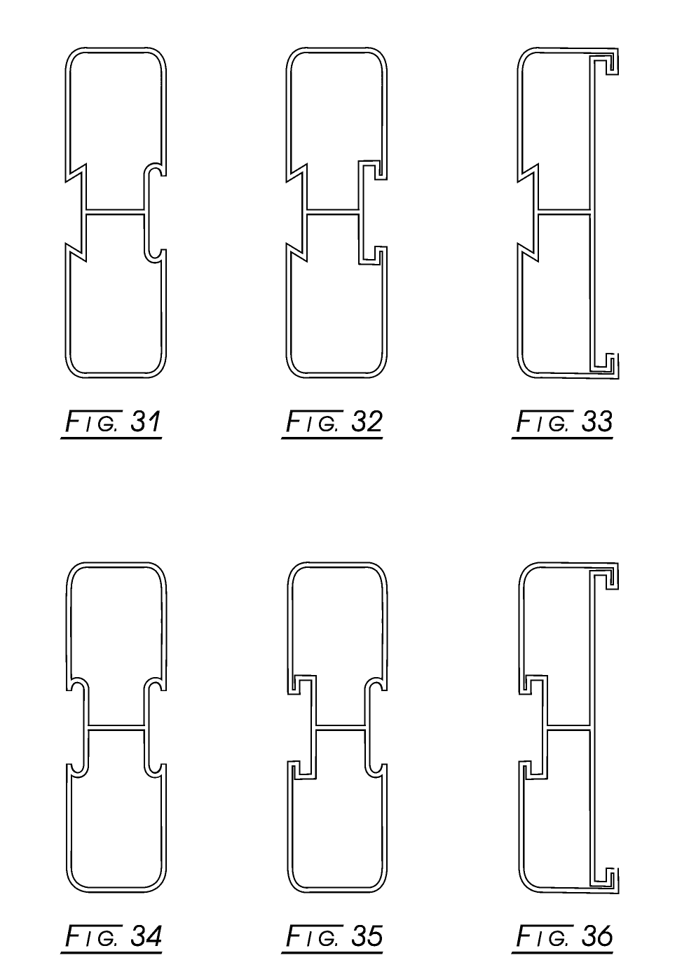

FIGS. 31-36 depict a variety of alternative profiles for the stay-in-place molds disclosed herein. In particular, the profile of the slots running down the lateral extent of the molds can be composed of flat sides, curvilinear sides, combinations of flat and curvilinear sides, etc., and still function in accordance with the precepts disclosed herein. Matching male profile clips can be configured to fit into such slots, move along the length of such slots, and be held fast in the slots. So, too, can the ends of the rebar clips be configured to fit within and be retained by such varied slot configurations.

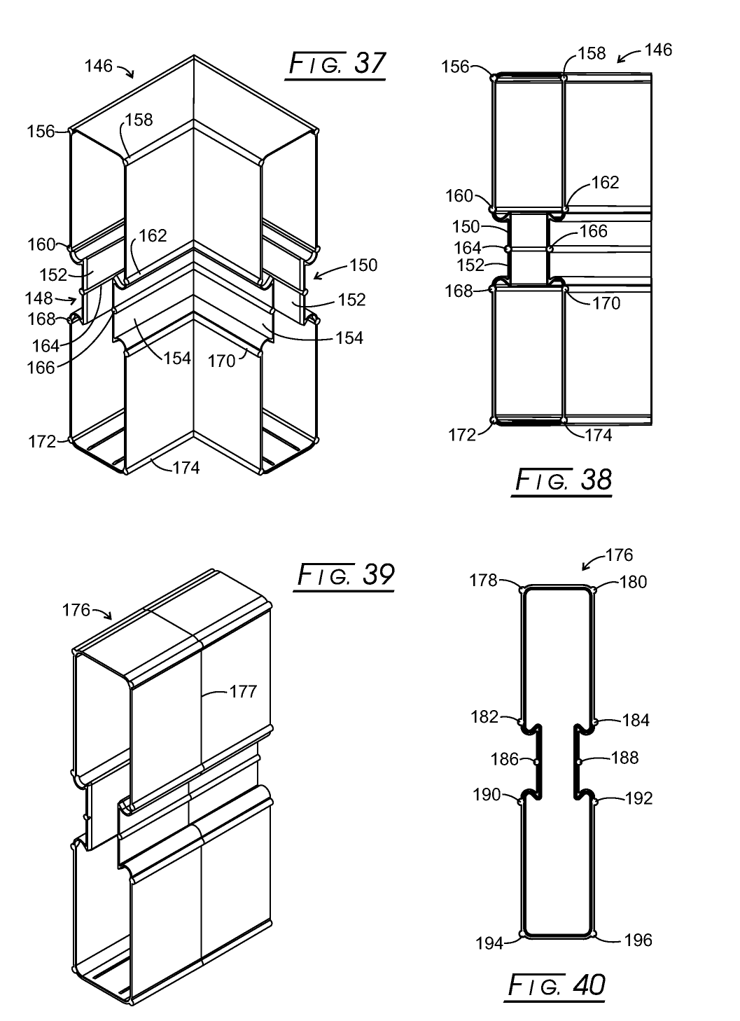

FIGS. 37 and 38 disclose a corner connector embodiment designed for easy mold removal. In particular, a corner connector, 146, has exterior dovetails, 148 and 150, that run the lengthwise extent of corner connector 146, for mating adjacent straight with the various concrete forms disclosed herein that have at least one side exterior dovetail. Also as with coroner connector 129 in FIGS. 25 and 26, central sections, 152 and 154, and their corresponding interior cavities taper from the interior to the ends of corner connector 146 for press friction fitting with straight forms that the connect at a corner of the footer.

Corner connector 146 also has ejector pin contact surface reinforcements formed integrally therewith. In particular, ejector pin contact surface reinforcements, 156-174, enable the corner connector in the mold to be pushed out easily and without distorting the molded part. The central portion of corner connector 146 also could be molded with slightly thicker wall thicknesses to aid in ejecting the part from the mold.

Referring now to FIGS. 39 and 40, a central or straight connector, 176, is illustrated. Connector 176 contains many of the features of corner connector 146, such as, ejector pin contact surface reinforcements, 178-196, tapering, and the like. Additionally, a vertical stop has been molded into the interior of connector 177 interiorly of a mold part line, 178. The vertical stop alerts the user as to when a straight mold section has been inserted the proper distance into connector 176.

While the invention has been described with reference to various embodiments, those skilled in the art will understand that various changes may be made and equivalents may be substituted for elements thereof without departing from the scope and essence of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims. In this application all units are in the metric system and all amounts and percentages are by weight, unless otherwise expressly indicated. Also, all citations referred herein are expressly incorporated herein by reference.

I claim:

1. A stay-in-place concrete footings form, wherein a concrete footing can be formed between a spaced-apart pair of said stay-in-place concrete footings forms, which comprises:
an elongate, hollow concrete footings form having a cavity inside said form, having a pair of elongate sides wherein openings are formed in said elongate sides to permit water to flow into the cavity;
said form having a dovetail pin or dovetail slot formed along the lengthwise extent of at least one side of said form, said dovetails permitting clamps having a mating dovetail slot or dovetail pin for clamping to said form for anchoring said form to the ground with a stake carried by said clamps.

2. The concrete footings form of claim 1, which has dovetail slots form along its lengthwise extent and said clamps have mating dovetail pins.

3. The concrete footings form of claim 1, which has dovetail pins form along its lengthwise extent and said clamps have mating dovetail slots.

4. The concrete footings form of claim 1, wherein one side has a dovetail slot and the other side has a dovetail pin.

5. The concrete footings form of claim 1, which is formed from plastic.

6. The concrete footings form of claim 1, wherein the top and bottom also have a dovetail pin or dovetail slot formed along its lengthwise extent.

7. The concrete footings form of claim 6, wherein a pair of said forms are stacked atop each other and a mating spline connects said forms together.

8. The concrete footings form of claim 6, wherein a fabric sheet is secured to the top dovetail pin or dovetail slot with a mating spline.

9. A pair of the concrete footings forms of claim 6 spaced apart with said secured fabric sheet therebetween.

10. The concrete footings form of claim 1, having a rebar clip secured to said dovetail tip or dovetail slot.

11. The concrete footings form of claim 10, wherein said rebar clip is formed from one or more of plastic or metal.

12. A concrete footer having the stay-in-place concrete footings form of claim 1 affixed thereto.

13. A concrete footer having the stay-in-place concrete footings form of claim 5 affixed thereto.

14. A concrete footer having the stay-in-place concrete footings form of claim 6 affixed thereto.

15. A concrete footer having the stay-in-place concrete footings form of claim 8 affixed thereto.

16. A concrete footer having the stay-in-place concrete footings form of claim 10 affixed thereto.

17. A pair of the concrete footings forms of claim 3, each having ends, wherein an end of each concrete footing is secured together by a connector having tapered elongate slots to receive said dovetail pins.

18. A pair of concrete footings forms of claim 3, which are placed at an angle to each other and secured by a corner connector having elongate slots to receive said dovetail pins.

19. The pair of concrete footings forms of claim 18, wherein said connector has an aperture in a side thereof.

20. The pair of concrete footings forms of claim 18, which are placed about orthogonally.

21. A clip for affixing to a pair of spaced-apart concrete footings forms having an upper edge and a longitudinal dovetail slot formed on at one side, said clip configured to receive and retain rebar between said forms, which comprises:
a central generally horizontal section having a at least two detents for rebar to rest upon;
a pair of generally upside down U-shaped ends, the U portion having a detent that fits into said dovetail slot, the U configured to clip over the upper edge of said forms.

22. The clip of claim 21, which is made from a metal.

23. The clip of claim 21, having ends, which ends are flared outwardly to facilitate the U-shaped ends clipping over the upper edge of said forms.

24. The clip of claim 21, wherein the U portion having a bend adjacent the concrete footer has a weakness added to enable the user to break off the portion of the clip extending out from the concrete footer.

25. The clip of claim 24, wherein the interior of said bend has been scored.

26. A connector for connecting two of the concrete footings form of claim 1, which comprises:
an elongate, hollow concrete connector having an interior upper cavity and an interior lower cavity, and having a pair of elongate sides at least one of which has a dovetail slot and separates the upper and lower interior cavities; said connector having a center from which said dovetail slot tapers from an end to said center; said connector additionally have a series of ejector pin contact surface reinforcements that extend longitudinally.

27. The connector of claim 26, which is straight.

28. The connector of claim 26, which is bent at said center.

29. The connector of claim 26, which has a dovetail slot that extends longitudinally on both sides of said connector.
